(19) United States
(12) Patent Application Publication
(10) Pub. No.: US 2006/0257832 A1
(43) Pub. Date: Nov. 16, 2006

(54) Focused four-minute feedback process

(76) Inventors: Stuart Atkins, Los Angeles, CA (US); Eric L. Dahl, Goleta, CA (US)

Correspondence Address: KENNETH J. HOVET;NORDMAN, CORMANY, HAIR & COMPTON LLP, P.O. BOX 9100, 1000 TOWN CENTER DRIVE, OXNARD, CA, 93031-9100, US

(21) Appl. No.: 11/126,666

(22) Filed: May 11, 2005

(51) Int. Cl. G09B 19/00

(52) U.S. Cl. 434/236

(57) ABSTRACT

The invention relates to a system and method for assessing and modifying personal strengths. The system first instructs a person to assess his/her personal strengths, then guides that person through a process of soliciting and collecting feedback from respondents known to the person. The system interprets the feedback and then enables the person to effectively utilize the feedback by providing individualized guidelines on modifying selected strengths, questions for developing a plan of modifying, e.g. enhancing or decreasing strengths, and standardized requests for more in-depth feedback about specific situations in which to practice the new behavior. This focused feedback can help a person to make the most of their strengths, reach personal and work goals faster, do what's best for themselves and others, and be more effective in their key relationships at work and at home.

### BACKGROUND OF THE INVENTION

Self-assessment surveys have been popular tools in employee and management development programs for decades. Stuart Atkins, one of the inventors of the Focused Four Minute Feedback Process, created and published one of the earliest such printed surveys, the LIFO® Survey, in 1967, which is now used in more then 30 countries around the world.

Because a person's self-understanding is often not entirely accurate, the results of self-assessment surveys are sometimes supplemented with results from “multi-rater” assessment surveys, such as the LIFO® Survey-AP (“Another Person”), also created by Atkins. These surveys are completed by other people to provide a broader understanding of the subject's behavior. The differences between the subject's self-assessment and the assessments of others may indicate opportunities for personal growth or skill deficits that the subject must fill in order to advance professionally.

Before the use of the Internet became widespread, self-assessments and multi-rater assessments were almost always completed using printed forms. Collating and interpreting the results and documenting the interpretations were time-consuming and expensive. In 1993, the inventors created one of the first computerized self-assessment and report systems, the LIFO® Report System. Since then, many other assessment tools and interpretive reports have been computerized and offered over the Internet.

Most self-assessment or multi-rater surveys consist of written statements or pairs of words. The user is typically instructed to rate how much each statement is like the subject or how the rater would rank the subject's behavior on a scale between each pair of words. Depending on the number of survey items, it can take 15-25 minutes or longer for a rater to complete a single survey, irrespective of whether it is about themselves or another person, and irrespective of whether it is completed in printed form or online. It is therefore impractical for all the members of even a relatively small group to complete assessment surveys on themselves and one another. For example, if there are eight group members and it takes 20 minutes to complete a survey on one person, the members of the group will have to spend a total of 27 person-hours completing the assessments. For this reason, the subjects of multi-rater assessments are typically only high-level managers or other selected individuals in whose development an organization is willing to invest significant time and money. It has thus been too costly for most groups of lower-level employees to participate in any kind of multi-rater assessment process in which all the group members give feedback to one another.

### SUMMARY OF THE INVENTION

It is therefore an object of the present invention to provide a cost-effective multi-rater assessment process that will allow groups of lower-level employees to participate in a multi-rater assessment process,

It is a further object of the current invention to provide a streamlined process of giving and receiving constructive feedback. Users are not required, as in prior self-assessment or multi-rater surveys, to read a long list of survey items and then make a considered response to each item. Instead, users make a few simple selections that take minutes rather than hours.

It is a further object of the present invention to provide a process that uses an intuitive graphical interface, such as the chart-based interface of the Focused Four Minute Feedback System, instead of the text-based interface used in previous assessment systems.

The first step in the process is for an individual initiator to select their own strengths, for example from options provided on the Four Minute Feedback Chart. The next step in the process is requesting feedback on these strengths from respondents that may include acquaintances, friends, colleagues, and family. To provide feedback, respondents view the initiator's self-assessment of personal strengths and make three sets of selections: (a) strengths they have seen the subject display: (b) one or two strengths they would like the subject to display more frequently; and (c) one or two strengths they would like the subject to display less frequently. The system then makes accessible to the subject a narrative interpretation of the feedback they have received, specific behavioral guidelines they can follow to moderate any strength they select, and a series of steps for planning how, where, and when they will change their behavior, and offers them an online tool for getting additional in-depth feedback about how they can modify their behavior.

The system of the current invention is a useful and practical method for soliciting, recording, collating, displaying, interpreting, and utilizing performance-improvement feedback. This feedback can help an initiator to make the most of their strengths, reach personal and work goals faster, do what's best for themselves and others, and be more effective in their key relationships at work and at home.

In this application for patent, the following terms have the following meanings:
server a CPU and memory operatively connected to said CPU for executing a program;
initiator: person who requests feedback;
respondents: people who give feedback to initiator.

### BRIEF DESCRIPTION OF THE DRAWINGS

FIGS. 1 and 2 are flowcharts that diagram how a user initiates use of the Focused Four Minute Feedback Process, how the system allows the initiator to assess his/her personal strengths, how the system guides the initiator through the steps for requesting and obtaining feedback from respondents, and how the system collates the feedback from the respondents for viewing by the initiator. These flowcharts also diagram the initiator's computer-driven use of each of the options on the system menu. The menu options support the Focused Four Minute Feedback Process by enabling the initiator to interpret and utilize the feedback received from the respondents.

### DETAILED DESCRIPTION OF THE DRAWINGS

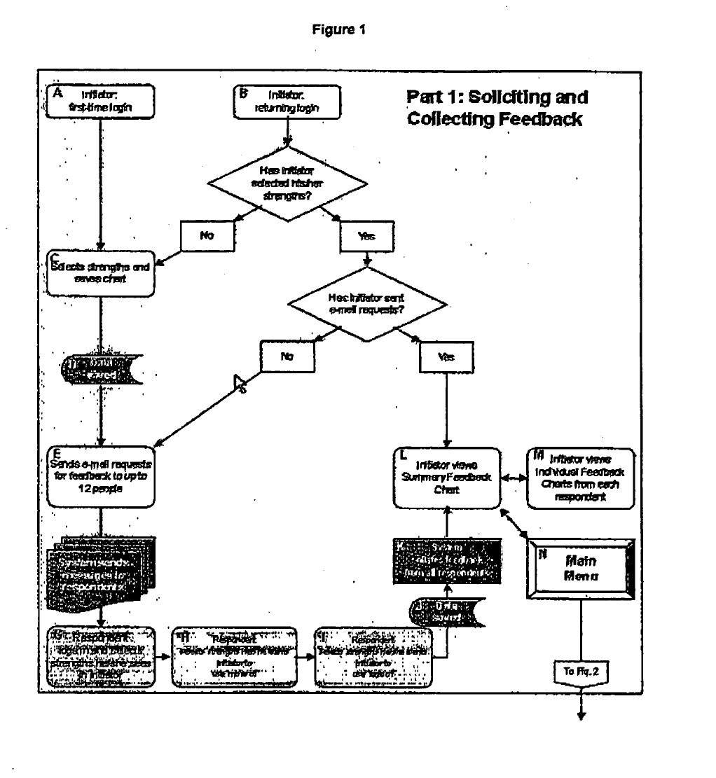

FIG. 1.A-B

The user purchases and initiates use of the system of the current invention, for example the Focused Four Minute Feedback Process, through the Internet. All users may be provided with a login name and password which allow returning users to access saved personal data in a confidential manner. The user may be an individual obtaining the system for his or her own use. The system can also be purchased by a company trainer or other individual for use by a group and all members of such a group can provide feedback for the other members. If the user has previously logged in and completed any of the steps C-E described below, the system directs the initiator to the appropriate next step in the process.

FIG. 1.C-D

After log-in, the first step in the process is for the user, or initiator, to assess their personal strengths. In the preferred embodiment, the initiator selects what they regard as their personal strengths from a chart listing a plurality of strength options. The Four Minute Feedback Chart represents the preferred embodiment of this chart. In this embodiment, strength options are selected from a circular chart that displays 40 words in four quadrants, with ten words in each quadrant. Strengths selected by the initiator are graphically indicated by the presence of a yellow dot placed next to each selected strength along the center of the chart. Initiator selections are saved by the system.

FIG. 1.E-F

The next step in the process is for the initiator to send a standardized e-mail message containing a request for feedback to one or more people, or respondents. The e-mail message contains an individualized URL, or link, that enables each respondent to view the initiators personal strength assessment, e.g. the Four Minute Feedback Chart The respondents may be from many sources, e.g. colleagues, boss, staff, friends and family. E-mails for requesting respondent feedback are standardized and included in the system. E-mails requesting feedback are sent via the system online.

FIG. 1.G-I

Each respondent uses the individualized link in the e-mail message to view the chart completed by the initiator and to select the strength words they regard as best describing the initiator, which may include strengths not chosen by the initiator. In the preferred embodiment of the invention, these selections are graphically indicated by yellow dots placed next to a strength description beside the selection but closer to the circumference of the circular chart. Next, each respondent selects the strengths they would like the initiator to augment to help the initiator reach their goals. In the preferred embodiment, these selections are graphically indicated by the presence of a different-colored dot, e.g. green dots, next to each selected strength. Then each respondent selects the strengths they would like the initiator to moderate to save the initiator time and increase the initiator's positive effect in key relationships. In the preferred embodiment, these selections are graphically indicated by the presence of a red dot next to each selected strength.

FIG. 1.J-K

Once the respondent has completed the selections referenced in steps G-I, the system saves the selections, closes the browser window in which the respondent was interacting with the initiator's chart, and blocks further viewing of the initiator's chart by the respondent, thereby helping to protect the confidentiality of the feedback. The system collates the data from all the respondents for presentation in a summary to display to the initiator. In the preferred embodiment of the invention, feedback data is collated into one summary Four Minute Feedback Chart.

FIG. 1.L-M

The initiator has access both to the feedback or charts completed by individual respondents and to the summary data or summary chart produced by the system.

FIG. 1.N

Once the initiator has completed steps A-M described above, they can view the Main System Menu, from which they can select options for interpreting and utilizing the feedback that they have received.

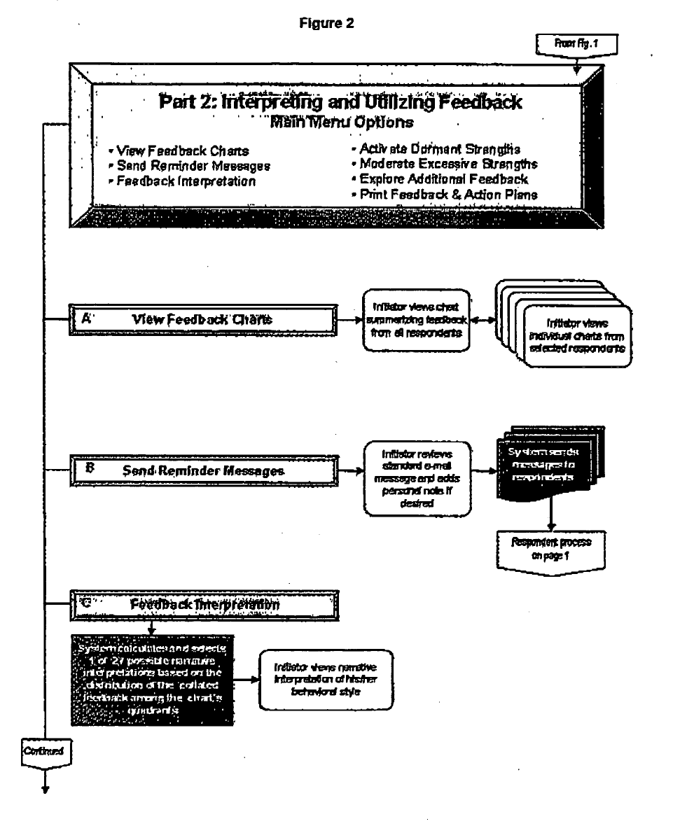

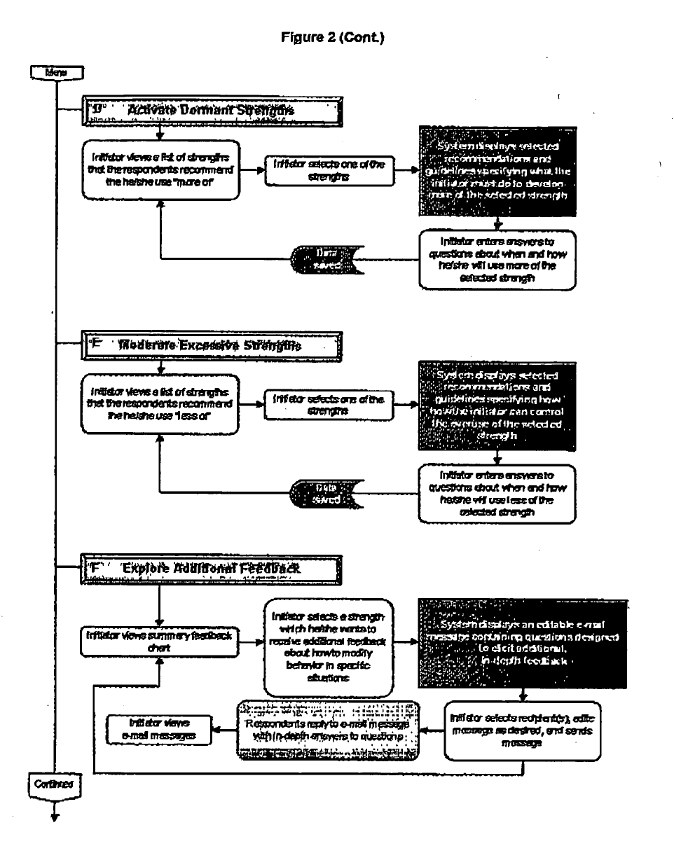

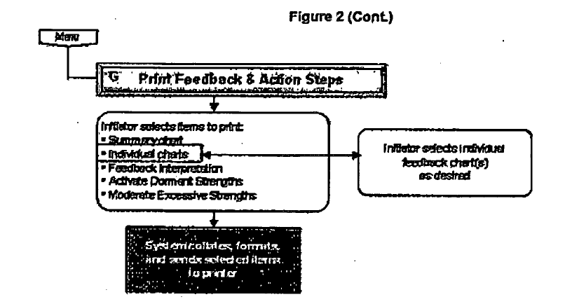

FIG. 2

The process continues after initial feedback receipt via initiator selection of system menu options.

FIG. 2.A

The initiator may review feedback. In the preferred embodiment of the invention, the initiator views feedback in chart form by selecting individual charts or the summary of individual charts.

FIG. 2.B

The initiator may send an editable standardized reminder message as is to one or more respondents or they may personalize reminder messages before sending.

FIG. 2.C

Based on the distribution of the collated feedback data, the system selects from the system database one of a plurality of narrative interpretations to display to the initiator. The initiator may view this narrative interpretation by selecting the appropriate menu option.

FIG. 2.D

To activate a dormant, e.g. under-utilized personal strength, the initiator views a list of strengths that respondents recommended that the initiator augment. The initiator selects a strength from this list and reads the system's guidelines that describe what the initiator can do to augment the selected strength. The initiator then answers questions on how and when they will augment the selected strength. This data is saved for future reference. The initiator may repeat this process for any of the strengths the respondents recommended the initiator augment.

FIG. 2.E

To moderate an over-utilized personal strength, an initiator views a list of strengths respondents recommended the initiator moderate. The initiator selects a strength from this list and reads the system's guidelines that describe what the initiator can do to moderate the selected-strength. The initiator then answers questions on how and when they will moderate the selected strength. This data is saved for future reference. The initiator may repeat this process for any of the strengths the respondents recommended the initiator moderate.

FIG. 2.F

To request in-depth respondent feedback, the initiator first views the summary data or chart and selects a strength about which they would like more specific feedback. The system displays a list of respondent names who gave feedback regarding the selected strength. The initiator may then send an editable standardized e-mail messages to one or more respondents containing questions eliciting in-depth feedback regarding in what situations and in what manner the initiator can modify their behavior in accordance with the feedback received from the respondents.

FIG. 2.G

The initiator may print any data stored by the system, including, but not limited to any feedback data, e.g. the summary chart or individual charts, the narrative interpretation of the feedback concerning their strength distribution, guidelines on how to activate or moderate a strength, and the initiator's plan for how and when to modify a strength. The system collates, formats and sends to a printer any data requested for printing.

What is claimed is:

1. A system for assessing an initiator's personal strengths comprising:
means for gathering said initiator's self-assessment of their strengths;
means to transmit said self-assessment to one or more respondents known to said initiator for feedback;
means for said respondent(s) to evaluate said initiator's strengths and those strengths said initiator should consider modifying;
means for said respondent(s) to communicate strength feedback to said initiator;
and means for collating said strength feedback for presenting a summary of one or more respondents' feedback about personal strengths to said initiator.

2. A system as in claim 1 further comprising means for evaluating said strength feedback and presenting a personalized strength profile to said initiator.

3. A system as in claim 1 further comprising means for said initiator to learn how to modify one or more strengths.

4. A system as in claim 1 further comprising means for said initiator to develop a plan for modifying one or more strengths.

5. A system as in claim 1 further comprising means for said initiator to elicit in-depth feedback from said respondent(s) on specific situations in which said initiator can modify one or more initiator-selected strengths.

6. A system as in claim 1 wherein said means for gathering personal strength information is a computer program comprising an interactive chart of enumerated strengths that allows an initiator to select one or more personal strengths from said chart and graphically displays selections on said chart.

7. A system as in claim 6 wherein said means for said respondent(s) to evaluate said initiator's strengths is said interactive chart which allows a respondent to select what they view as said initiator's strengths from those listed in the chart, to indicate strengths said initiator should modify, and to observe said selections.

8. A method of assessing and planning modification of an initiator's strengths using a server adapted to be accessed via the Internet, the method comprising the steps of:
said initiator creating a personal strength assessment via a personal computer connected to said server by selecting one or more personal strengths from a plurality of strength options presented by said program via a graphical display means;
said respondent(s) indicating initiator's strengths, including which strengths said initiator should modify, on a standardized form on the server, which automatically notifies via e-mail said initiator when each responder submits feedback;
said respondent(s) indicating initiator's strengths on a standardized form on the server, including indicating which strengths said initiator should modify, and returning feedback to said initiator via e-mail;
and said program collating feedback response data and presenting on the basis of the distribution of collated responses a summary of feedback data for viewing by said initiator.

9. A method as in claim 8 in which said request for feedback e-mailed to one or more respondents is accompanied by a password-protected link to said server-based personal strength assessment

10. A method as in claim 8 further comprising the step of said program displaying to said initiator one of a plurality of narrative interpretations based on the distribution of strengths on said summary of feedback data.

11. A method as in claim 8 further comprising the step of said initiator viewing individualized guidelines accessible through said program specifying what said initiator can do to modify selected strength(s).

12. A method as in claim 8 further comprising the step of said initiator answering questions accessible through said program regarding how and when to modify said selected strength(s).

13. The method of claim 8 further comprising the step of said initiator soliciting in-depth feedback about specific situations in which said initiator can modify said selected strength(s) from said respondent(s) by sending to one or more respondents an editable standardized e-mail message and subsequently receiving responses to said standardized e-mail messages.

14. A method of assessing and enhancing an individual's personal strengths, the method comprising the steps of:
an initiator selecting self-assessed strengths from a chart of enumerated strengths to create a chart of personal strengths;
said initiator sending an e-mail message to one or more respondents that includes a link to said server-based feedback chart along with instructions for giving feedback;
said respondent(s) filling out said chart by selecting what they view as initiator's strengths and strengths the initiator should consider modifying;
and said initiator accessing one or more of said completed feedback charts and a summary chart of said completed feedback charts.

15. A method as in claim 13 further comprising the step of said initiator accessing guidelines on how to modify one or more initiator-selected strengths.

16. A method as in claim 13 further comprising the step of said initiator answering questions about when and how to modify said initiator-selected strength(s).

17. The method of claim 13 further comprising the steps of:
said initiator requesting in-depth feedback about specific situations in which said initiator can modify said selected strengths from one or more respondents by sending an editable standardized email or other form of standardized communication to said respondent(s) containing questions designed to elicit in-depth feedback; and
said initiator viewing feedback returned to them by respondent(s) via e-mall or other form of communication.
